(19) United States
(12) Patent Application Publication
(10) Pub. No.: US 2006/0082017 A1
(43) Pub. Date: Apr. 20, 2006

(54) Method and an apparatus for the production of articles made of moulded plastic material particularly by means injecto-compression

(75) Inventors: Afro Rossanese, Noventa di Piave (IT); Maurizio Bazzo, Oderzo (IT)

Correspondence Address: HESLIN ROTHENBERG FARLEY & MESITI PC, 5 COLUMBIA CIRCLE, ALBANY, NY, 12203, US

(73) Assignee: INCOS S.p.A., San Polo di Piave (Treviso) (IT)

(21) Appl. No.: 11/047,483

(22) Filed: Jan. 31, 2005

(30) Foreign Application Priority Data
Oct. 15, 2004 (IT) TO2004A000716

(51) Int. Cl. B29C 45/00

(52) U.S. Cl. 264/255; 264/328.7; 264/328.8; 425/555

(57) ABSTRACT

Described herein are a process and apparatus for the production of articles made of moulded plastic material by means of injection or injecto-compression, in which the volume of the moulding chamber is selectively varied in a controlled way in localized areas so as to recover possible errors of dosing of the injected plastic material and completing its compression.

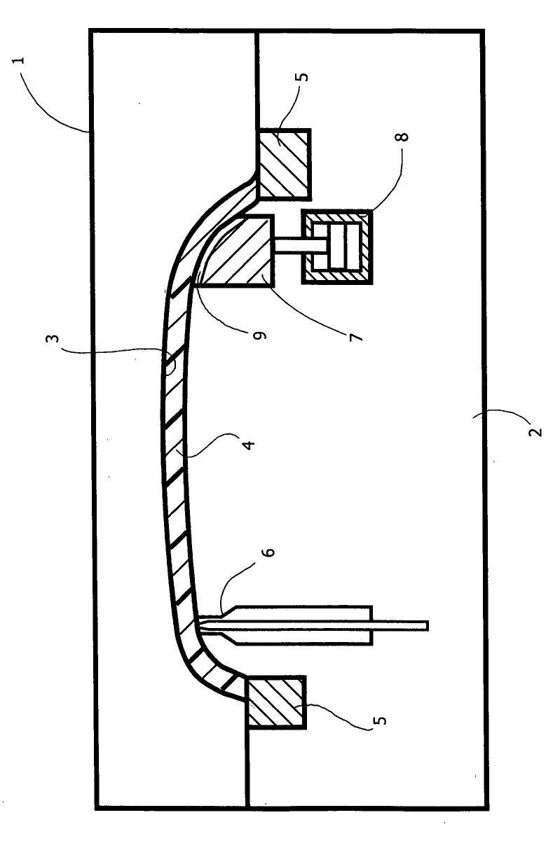

### CROSS-REFERENCE TO RELATED APPLICATIONS

This application claims priority from Italian application number T02004A000716, filed on Oct. 15, 2004, the entire disclosure of which is incorporated herein by reference.

This application also relates to U.S. patent application Ser. No. ______ (Attorney Docket No. 2177.007), filed on the same day as the present patent application, and titled “AN APPARATUS AND A METHOD FOR THE INJECTION-COMPRESSION MOULDING OF ARTICLES MADE OF PLASTIC MATERIAL WITH TWO COMPONENTS,” the contents of which are incorporated herein by reference.

This application also relates to U.S. patent application Ser. No. ______ (Attorney Docket No. 2177.008), filed on the same day as the present patent application, and titled “A PROCESS FOR THE PRODUCTION OF PLATES MADE OF TRANSPARENT PLASTIC MATERIAL WITH NON-TRANSPARENT AREAS,” the contents of which are incorporated herein by reference.

This application also relates to U.S. patent application Ser. No. ______ (Attorney Docket No. 2177.009), filed on the same day as the present patent application, and titled “A PROCESS FOR THE PRODUCTION OF PLATES MADE OF TRANSPARENT PLASTIC MATERIAL WITH NON-TRANSPARENT OVERINJECTED PARTS,” the contents of which are incorporated herein by reference.

This application also relates to U.S. patent application Ser. No. ______ (Attorney Docket No. 2177.011), filed on the same day as the present patent application, and titled “AN APPARATUS AND A METHOD FOR INJECTO-COMPRESSION MOULDING OF ARTICLES MADE OF PLASTIC MATERIAL WITH TWO COMPONENTS,” the contents of which are incorporated herein by reference.

This application also relates to U.S. patent application Ser. No. ______ (Attorney Docket No. 2177.012), filed on the same day as the present patent application, and titled “A PROCESS FOR THE PRODUCTION OF PLATES MADE OF PLASTIC MATERIAL WITH PARTS OVERMOULDED BY INJECTO-COMPRESSION,” the contents of which are incorporated herein by reference.

This application also relates to U.S. patent application Ser. No. ______ (Attorney Docket No. 2177.013), filed on the same day as the present patent application, and titled “A METHOD FOR THE PRODUCTION OF PLATES MADE OF PLASTIC MATERIAL WITH PARTS OVERMOULDED BY INJECTO-COMPRESSION,” the contents of which are incorporated herein by reference.

This application also relates to U.S. patent application Ser. No. ______ (Attorney Docket No. 2177.014), filed on the same day as the present patent application, and titled “AN APPARATUS AND A PROCESS FOR THE INJECTO-COMPRESSION MOULDING OF ARTICLES MADE OF PLASTIC MATERIAL WITH TWO COMPONENTS,” the contents of which are incorporated herein by reference.

### FIELD OF THE INVENTION

The present invention relates in general to the production of articles made of moulded plastic material by means of injection or injecto-compression.

### STATE OF THE PRIOR ART

Traditionally, the plastic material in the fluid state is injected in a moulding chamber defined between a stationary mould and a countermould, which is mobile with respect to the mould between a position of opening and a position of closing of the moulding chamber. In the case of injecto-compression, the plastic material is injected, maintaining the countermould in, or bringing it back into, a position of half-opening, and hence the complete closing of the countermould (whether simultaneous with or subsequent to injection) produces a post-compression of the material injected for forming the article.

The normal presses for injection moulding carry out the injection process with a high pressure, controlling the speed of injection. Towards the end of the injection, i.e., when the cavity of the moulding chamber is almost completely filled, it becomes necessary to carry out a step of post-pressure, otherwise referred to as “pressure holding”, which has two basic functions:

guaranteeing that the plastic material remains in good conditions of pressure during cooling (compensation of the shrinkage of the material); and

injecting exactly the amount of material necessary for completing filling of the cavity.

When the process of injecto-compression is carried out, the normal step of pressure holding must be obtained, theoretically, only by the countermould in so far as the final step of the process of compression can be obtained with the injection system closed. The pressure that is reached within the moulding chamber depends upon the amount of material previously injected. It is obvious that minimal variations in the amount of material injected generate big variations of pressure on the material at the end of the compression. The moulding chamber has a very precise volume and requires, in order to achieve correct dimensional tolerances, that at the end it will be completely closed and the material will be subjected to a pressure that can be regulated and distributed as uniformly as possible.

With the process of injecto-compression used traditionally with usual moulding presses it is very difficult to dose exactly the amount of plastic material present in the cavity and differences of compacting of the material and/or differences of thickness may be generated. In other words, the process is not very stable and can entail a considerable percentage of rejects.

Attempts to solve said problems envisage in the mould wells for discharge of the material, or overflow cavities, or other equivalent systems, accepting differences of thickness.

The problems of lack of compacting of areas close to the injection spots can also be solved using a step of pressure holding by activating it at the end of the step of compression. The pressure that is developed in this way acts, however, only in areas close to the injection spots, and not in other more distant ones.

The problem is even more critical in the case of moulding by means of injecto-compression for forming plates of large dimensions, whether transparent ones (such as windows in the automotive field or screens for plasma televisions) or non-transparent ones. The shapes that the article to be moulded can assume are extremely varied and, at times, very complex. In many cases with normal injecto-compression it is not possible to obtain a proper compacting effect in each area of the mould, above all because there could exist areas that require different compacting pressures.

### SUMMARY OF THE INVENTION

The purpose of the present invention is to provide an effective solution to the aforesaid technical problem, obtaining a recovery of possible errors of dosing of the plastic material injected in the moulding chamber as regards the injection step, whilst also completing the compression of the material as regards the possible step of injecto-compression.

With a view to achieving said purpose, the subject of the present invention is a process of the type defined above, the essential characteristic of which lies in the fact that the volume of said moulding chamber is selectively varied in a controlled way in localized areas to recover possible errors of dosing of the injected plastic material and/or possible differences of pressure.

The controlled variation of the volume of said moulding chamber produces variations of thickness of the moulded article in said localized areas.

In the case where the moulding process consists, instead of just injection, of an injecto-compression, the aforesaid step of selective and controlled variation of volume is conducted during the step of compression.

The process according to the invention thus enables effective recovery of possible errors or differences of dosing of the injected plastic material, maintaining the conditions of pressure within the cavity of the mould required for correct moulding of the material.

The system forming the subject of the present invention can be used also to transfer pressure and hence guarantee optimal compacting in the areas where, by means of the normal step of compression (mould closing), it could not be possible to guarantee optimal pressure. The invention is in this case able to guarantee an optimal distribution of the pressures also on products with very inclined walls, where the pressure is normally deficient.

Furthermore, the areas where the system operates may be localized or even continuous (for example, on the entire perimetral edge of a plate of large dimensions) so as to distribute the variation of thickness over a larger surface and in any case in an optimal way.

The areas where localized variations of pressure are applied will of course depend upon the shape of the articles to be moulded and upon the conditions of injection adopted within the mould. The variations of pressure will generate said variations of thickness of the moulded article. Said variations of thickness may be managed as increase in thickness with respect to the nominal thickness in areas contiguous to the ones corresponding to where the localized pressures are applied, or else as a reduction in thickness with respect to the nominal thickness in said localized areas, or else again within a range around the nominal value as a function of various parameters, amongst which the errors of dosing, the areas available, etc.

The use of the process according to the invention is particularly advantageous in many applications, amongst which, for example, the following:

1. injection moulding with problems of pressure holding of the material, which cannot be solved with just the injection parameters;

2. injecto-compression moulding of a mono-component article with problems of dosage and critical areas;

3. injecto-compression moulding in the moulding of the first component of a bi-component article; and

4. injecto-compression moulding in the step of over-injection of the second component on the first component of a bi-component article.

Also a subject of the present invention is an apparatus for implementation of the process, basically characterized in that it comprises mobile members for varying selectively and in a controlled way the volume of said moulding chamber in localized areas, and actuator means for actuating said mobile members. Said actuator means can include fluid-controlled jacks, elastic members, and equivalent systems.

### BRIEF DESCRIPTION OF THE DRAWING

The invention will now be described in detail with reference to the annexed drawing, which is provided purely by of way of non-limiting example and is a schematic representation in partial cross section of an apparatus for the production of articles of moulded material according to the invention.

### DETAILED DESCRIPTION OF THE INVENTION

Represented schematically in the FIGURE is a mould for the production of articles made of moulded plastic material by means of injection or injecto-compression, including in a usual way a mould 1, which is, for example, stationary, and a countermould 2, which is, for example, mobile with respect to the mould 1 between a position of opening and a position of closing, illustrated in the drawing, to define a cavity or moulding chamber 3, within which the moulded article 4 is formed. In the case where the moulding, in addition to injection, envisages a step of compression, performed simultaneously with or subsequently to the injection step, the countermould 2 may be positioned in a condition of half-opening of the moulding chamber 3 during the injection step.

Once again in the case of injecto-compression, the countermould 2 may be equipped with a mobile frame 5 to obtain peripheral closing of the moulding chamber 3 during the step of compression.

One or more injectors 6 inject the fluid plastic material directly within the chamber 3 during the injection step, simultaneously with or subsequently to which there is possibly conducted the step of compression.

According to the invention the countermould 2 is equipped with one or more mobile members 7 that can be displaced between a retracted position and an advanced position, for example, via respective fluid-controlled jacks 8, or else elastic or equivalent systems, carried by the countermould 2.

The mobile element or each mobile element 7 is able to determine, according to its selective and controlled positioning obtained by the corresponding actuator 8, a controlled variation of the volume of the moulding chamber 3 in the localized area corresponding thereto. In the case of the example illustrated, it defines an additional volume 9, which will enable recovery of possible errors of dosing of the injected plastic material, maintaining the conditions of pressure required for correct moulding of the material by exerting a localized pressure in the position where it is necessary for said pressure to be present. Said localized pressure will produce a variation of thickness of the moulded article in the corresponding area.

The shapes of the mobile elements 7 and the areas in which they are positioned will depend upon the characteristics and the shape of the articles to be moulded, as well as upon the conditions of moulding envisaged. The variations of thickness will be generated then only in a position corresponding to the mobile elements or each mobile element 7, and said variations may be managed both as an increase in thickness with respect to the nominal thickness and as a reduction in thickness with respect to the nominal thickness or also as a range around the nominal value as a function of the stroke of the mobile elements or each mobile element 7, the errors of dosing, the areas available, etc.

As already clarified previously, the use of the mobile elements 7 finds advantageous application in the case of moulding by mere injection when there arise problems of pressure holding of the material, which cannot be solved with normal injection parameters, both—and in particular—in the case of injecto-compression moulding of mono-component articles with problems of dosage and critical areas of the moulded article, in the case of injecto-compression moulding of the first component of an article with two components, and in the case of injecto-compression moulding of the second component overmoulded on the first, once again in the case of a bi-component article.

The mobile elements 7 may also be advantageously used in both of the steps of a process of injecto-compression moulding of the one and of the other component of a bi-component article.

It should be noted that, in the case of application to the moulding by means of injecto-compression of the first component of a bi-component article, the variation of thickness that is obtained in an area corresponding to the mobile elements 7 or each mobile element 7 for the recovery of the errors of dosing of the plastic material and/or for restoring the conditions of pressure can be masked in the case where said variation corresponds to an area or to areas that are subsequently covered as a result of the overmoulding of the second component. The variations of thickness may in any case be of very modest proportions, and said variations will prove practically invisible following upon moulding of the second component also in the case where the first component is constituted by a plate made of transparent plastic material, for example, polycarbonate.

Furthermore, the areas where the mobile elements 7 will be provided may be localized or else continuous (for example, on the entire perimetral edge of a plate of large dimensions) so as to distribute the variation of thickness over a larger surface and in a way that is in any case optimal.

Of course, the details of construction and the embodiments may vary widely with respect to what is described and illustrated herein, without thereby departing from the scope of the present invention, as defined in the ensuing claims.

1. A process for the production of articles made of plastic material by means of injection in a moulding chamber having a volume defined between a stationary mould and a countermould, which is mobile with respect to the mould between a position of opening and a position of closing of said moulding chamber, wherein the volume of said moulding chamber is selectively varied in a controlled way in localized areas for recovering at least one of possible errors of dosing of the injected plastic material and possible differences of pressure.

2. The process according to claim 1, wherein the controlled variation of the volume of said moulding chamber produces variations of thickness of the moulded article in said localized areas.

3. The process according to claim 2, further comprising a step of compression of the injected plastic material within said moulding chamber, wherein said controlled variation of the volume of the moulding chamber is conducted during said step of compression.

4. The process according to claim 3, wherein the injection and the step of compression comprise injecto-compression moulding of articles with two components in two successive steps.

5. The process according to claim 4, wherein the injection and the step of compression comprises a step of injecto-compression of a first component of the two components.

6. The process according to claim 4, wherein the injection and the step of compression comprises a step of injecto-compression of the second component overmoulded on the first component.

7. The process according to claim 4, wherein the injection and the step of compression comprise a step of injecto-compression of both of the components.

8. The process according to claim 7, wherein said first component is a plate made of transparent plastic material.

9. The process according to claim 8, wherein said localized areas in a position corresponding to which the volume of said moulding chamber is varied are subsequently covered by the second component.

10. The process according to claim 1, wherein the variation of said volume is performed using mobile members carried by said countermould and actuated via respective actuators.

11. An apparatus for the production of articles made of moulded plastic material by means of injection in a moulding chamber having a volume defined between a stationary mould and a countermould mobile with respect to the mould between a position of opening and a position of closing in said moulding chamber, said apparatus comprising mobile members for varying selectively in a controlled way the volume of said moulding chamber in localized areas, and actuator means for actuating said mobile members.

12. The apparatus according to claim 11, wherein said mobile members produce variations of thickness of the moulded article in said localized areas.

13. The apparatus according to claim 12, designed to perform a step of compression of the plastic material injected within said moulding chamber, wherein said mobile members are activated by said actuator means during said step of compression.

14. The apparatus according to claim 13, wherein said mobile members are carried by said countermould.

15. The apparatus according to claim 14, wherein said actuator means include fluid-controlled jacks.

16. The apparatus according to claim 14, wherein said actuator means include elastic members.
